(19) United States
(12) Patent Application Publication
(10) Pub. No.: US 2011/0170974 A1
(43) Pub. Date: Jul. 14, 2011

(54) DRILL

(75) Inventor: Norihiro Masuda, Toyokawa-shi (JP)

(73) Assignee: OSG CORPORATION, Toyokawa-shi, Aichi (JP)

(21) Appl. No.: 13/119,592

(22) PCT Filed: Sep. 30, 2008
(86) PCT No.: PCT/JP2008/067773

§ 371 Date: Mar. 17, 2011

(51) Int. Cl. B23B 51/02

(52) U.S. Cl. 408/230

(57) ABSTRACT

It is provided a drill having a plurality of twist grooves disposed around a drill axial center O and main cutting edges formed along their respective twist grooves in opening portions of the twist grooves at a drill tip, the drill being subjected to thinning in the vicinity of the drill axial center O at the drill tip to dispose thinning edges smoothly connected to the main cutting edges, the drill being disposed with the three or more twist grooves and the three or more main cutting edges, the main cutting edges having a negative angle portion in an outer peripheral portion having a radial rake angle φ within a range of −20°≦φ<0° in a bottom view from the drill tip side and a shape curved convexly toward the drill rotation direction, the negative angle portion being formed in a range L not greater than 0.1 D relative to a drill diameter D from an outer peripheral corner, the main cutting edge forming a concave arc shape smoothly recessed such that it projects toward a side opposite to a drill rotation direction beyond a straight line that passes through the outer peripheral corner and the drill axial center O in the bottom view in a portion closer to the drill axial center O than the negative angle portion, and a ratio between a land width angle θ₁ around the drill axial center O and a groove width angle θ₂ of the twist grooves being within a range of 35:65 to 65:35.

### TECHNICAL FIELD

The present invention relates to a drill and, more particularly, to a drill capable of highly efficient process at a high feed rate.

### BACKGROUND ART

For a rotary cutting tool for a boring process, a drill is known that has a plurality of twist grooves disposed around a drill axis center and main cutting edges formed along their respective twist grooves in opening portions of the twist grooves at a drill tip and that is subjected to thinning in the vicinity of the drill axial center at the drill tip to dispose thinning edges smoothly connected to the main cutting edges. By way of example, a drill described in Patent Document 1 has an outer peripheral portion of a main cutting edge disposed with a negative angle portion having a negative radial rake angle in a bottom view from the drill tip side within a predetermined range from an outer peripheral corner, enhancing the cutting edge strength in the vicinity of the outer peripheral corner and suppressing the occurrence of a defect, etc. Patent Document 2 describes a three-blade drill having a three twist grooves.
Patent Document 1: Japanese Patent Publication No. 4120186
Patent Document 2: Japanese Laid-Open Patent Publication No. 2002-103123

### DISCLOSURE OF THE INVENTION

### Problems to Be Solved by the Invention

However, the drill described in the Japanese Patent Publication No. 4120186 has two blades with two twist grooves and, especially when cutting steel, if the high feed rate process is performed with a feed amount per rotation exceeding 0.05 D relative to a drill diameter D (5% of D), a depth of cut per blade increases and a defect may occur due to insufficient cutting edge strength, leading to a lack of stability. If a web thickness is thickened to increase the cutting edge strength, chips cut out thick at a high feed rate are not parted with favorable chip curl in the groove, reducing the chip evacuation and easily causing a break due to chip clogging. On the other hand, in the case of the three-blade drill described in Japanese Laid-Open Patent Publication No. 2002-103123, although it is not necessary to dispose a negative angle portion as described in Japanese Patent Publication No. 4120186 in an outer peripheral portion of a main cutting edge for preventing a defect, etc., in a normal boring process, if a boring process is performed at a high feed rate, a defect at an outer peripheral corner portion is induced and, when high-speed cutting or a deep hole process is performed, the chip evacuation deteriorates because of a small curvature of the chip curl.

The present invention was conceived in view of the situations and it is therefore an object of the present invention to provide a drill capable of a highly efficient process at a high feed rate such as a feed amount per rotation exceeding 5% of the drill diameter D.

### Means for Solving the Problems

To achieve the above object, the first aspect of the present invention provides a drill having a plurality of twist grooves disposed around a drill axial center O and main cutting edges formed along their respective twist grooves in opening portions of the twist grooves at a drill tip, the drill being subjected to thinning in the vicinity of the drill axial center O at the drill tip to dispose thinning edges smoothly connected to the main cutting edges, (a) the drill being disposed with the three or more twist grooves and the three or more main cutting edges, (b) the main cutting edges having a negative angle portion in an outer peripheral portion with a radial rake angle φ within a range of −20°≦φ<0° in a bottom view from the drill tip side, the negative angle portion being formed in a range L not greater than 0.1 D relative to a drill diameter D from an outer peripheral corner, (c) the main cutting edge forming a concave arc shape smoothly recessed toward a side opposite to a drill rotation direction in the bottom view in a portion closer to the drill axial center O than the negative angle portion.

The second aspect of the invention provides the drill recited in the first aspect of the invention, wherein a ratio (the land/groove ration) between a land width angle θ₁ around the drill axial center O and a groove width angle θ₂ of the twist grooves is within a range of 35:65 to 65:35.

The third aspect of the invention provides the drill recited in the first or second aspect of the invention, wherein a web thickness W at the drill tip is within a range of 0.25 D to 0.45 D relative to the drill diameter D.

The fourth aspect of the invention provides the drill recited in the any of the first to third aspects of the invention, wherein an axial rake angle of the thinning edges is within a range of −5° to 0° in a portion closest to the drill axial center O and smoothly and continuously increases to be within a range of 0° to +15° in a connection portion for the main cutting edge from the side of the drill axial center O toward the connection portion.

The fifth aspect of the invention provides a drill having a plurality of twist grooves disposed around a drill axial center O and main cutting edges formed along their respective twist grooves in opening portions of the twist grooves at a drill tip, the drill being subjected to thinning in the vicinity of the drill axial center O at the drill tip to dispose thinning edges smoothly connected to the main cutting edges, (a) the drill being disposed with the three or more twist grooves and the three or more main cutting edges, (b) the main cutting edges having a negative angle portion in an outer peripheral portion with a radial rake angle φ within a range of −20°≦φ<0° in a bottom view from the drill tip side, the negative angle portion being formed in a range L not greater than 0.1 D relative to a drill diameter D from an outer peripheral corner, (c) the main cutting edge forming a concave arc shape smoothly recessed toward a side opposite to a drill rotation direction in the bottom view in a portion closer to the drill axial center O than the negative angle portion, (d) the drill having a ratio (the land/groove ratio) between a land width angle θ₁ around the drill axial center O and a groove width angle θ₂ of the twist grooves within a range of 35:65 to 65:35, (e) the drill having a web thickness W at the drill tip within a range of 0.25 D to 0.45 D relative to the drill diameter D, (0 the drill having an axial rake angle of the thinning edges within a range of −5° to 0° in a portion closest to the drill axial center O, the axial rake angle smoothly and continuously increasing to be within a range of 0° to +15° in a connection portion for the main cutting edge from the side of the drill axial center O toward the connection portion.

The sixth aspect of the invention provides the drill recited in the any of the first to fifth aspects of the invention, wherein the drill is capable of a high feed rate process for steel with a feed amount per rotation exceeding 5% of the drill diameter D and is capable of a high feed rate process for aluminum alloy with a feed amount per rotation exceeding 30% of the drill diameter D.

### The Effects of the Invention

In the drill as described above, since the three or more main cutting edges are disposed, the web thickness W can be increased to improve the rigidity while ensuring a predetermined chip evacuation performance; the centripetal property is improved to suppress the center deviation; and an enlargement amount of a processed hole diameter is reduced to enhance a processed hole accuracy. On the other hand, since the outer peripheral portions of the main cutting edges are disposed with the negative angle portions having a negative radial rake angle φ, the cutting edge strength is improved in the vicinity of the outer peripheral corners and, due to the synergetic effect, chipping-off and defects or the like are suppressed in the vicinity of the outer peripheral corners and a highly efficient process can be executed at a high feed rate even if a boring process is performed at a high feed rate with a feed amount per rotation exceeding 5% of the drill diameter D in the case of steel and 30% of the drill diameter D in the case of aluminum alloy, for example, as the sixth aspect of the invention.

In such a case, since the radial rake angle φ of the negative angle portions is within a range of −20°≦φ<0° and the range L of the negative angle portions is equal to or less than 0.1 D from the outer peripheral corner, the increase in the cutting resistance and the thrust resistance or the reduction of sharpness due to a negative angle is suppressed to the requisite minimum, and the highly efficient process at a high feed rate is enabled as a whole. The portion closer to the drill axial center O than the negative angle portion is formed into a concave arc shape smoothly recessed toward the side opposite to the drill rotation direction and, therefore, the chip evacuation performance is improved since chips are promoted to curl up and easily parted while a cutting load is distributed due to a cutting edge length longer than a linear cutting edge, which is advantageous for the highly efficient process at a high feed rate.

Therefore, the chip evacuation performance and the tool rigidity and cutting edge strength are improved in a balanced manner while suppressing increases in the cutting resistance and the thrust resistance to enable the highly efficient process performed at a high feed rate, and the drill can be used in a preferred manner for the boring processes of various work materials from cast iron and general steel requiring a relatively high rigidity, to aluminum alloy, etc., causing poor chip evacuation.

In the second aspect of the invention, the land/groove ratio θ₁:θ₂ is within a range of 35:65 to 65:35 and, therefore, the chip evacuation performance and the tool rigidity and cutting edge strength can be ensured in a balanced manner, which is advantageous for the highly efficient process at a high feed rate.

In the third aspect of the invention, the web thickness W at the drill tip is within a range of 0.25 D to 0.45 D relative to the drill diameter D and, therefore, the chip evacuation performance and the tool rigidity and cutting edge strength can be ensured in a balanced manner, which is advantageous for the highly efficient process at a high feed rate.

Since the axial rake angle of the thinning edges is within a range of −5° to 0° in the portion closest to the drill axial center O and smoothly and continuously increases to be within a range of 0° to +15° in the connection portions for the main cutting edges from the side of the drill axial center O toward the connection portion in the fourth aspect of the invention, a predetermined blade edge strength can be ensured while suppressing increases in the cutting resistance and the thrust resistance and, therefore, the defects are suppressed in the connection portions between the thinning edges and the main cutting edges, which is advantageous for the highly efficient process at a high feed rate.

The fifth aspect of the invention has the all requirements in the first to fourth aspects of the invention. Therefore, the same actions and effects as the first to fourth aspects of the invention can be obtained and it permits a highly efficient process at a high feed rate such as a feed amount per rotation exceeding 5% of the drill diameter D.

### BRIEF DESCRIPTION OF THE DRAWINGS

FIGS. 1A and 1B depict a drill that is an embodiment of the present invention; FIG. 1A is a front view; and FIG. 1B is an enlarged bottom view from the tip side.

FIG. 2 depicts a cross-section view normal to the drill axial center O, showing the land width angle θ₁ and the groove width angle θ₂.

FIGS. 3A and 3B are diagrams for explaining a result when two three-blade drills having the different negative angle range and a typical two-blade drill are prepared to examine thrust resistances by performing a boring process under the predetermined test condition.

FIGS. 4A and 4B are diagrams for explaining a result when a plurality of three-blade drills having the different radial rake angles φ are prepared to examine the thrust resistances by performing boring processes under the predetermined test condition and the cutting statuses are observed to judge whether good or bad in a comprehensive manner.

FIGS. 5A and 5B are diagrams for explaining a result when a plurality of three-blade drills having the different web thicknesses W are prepared to perform a boring process while increasing a feed amount under the predetermined test condition and examine limit values of feed amounts.

FIGS. 6A and 6B are diagrams for explaining a result when a plurality of three-blade drills having the different land/groove ratios θ₁:θ₂ are prepared to perform a boring process while increasing a feed amount under the predetermined test condition and examine limit values of feed amounts.

FIGS. 7A to 7C are diagrams for explaining a result when a plurality of three-blade drills having a differential axial rake angle of the thinning edges are prepared to perform a boring process under the predetermined test condition and to examine the cutting resistances ratio and the blade edge strengths.

FIGS. 8A to 8D are diagrams for explaining a result when a product of the present invention and two comparative products are prepared and a boring process is performed under the predetermined test condition to examine durability and amounts of wear.

FIGS. 9A to 9D are diagrams for explaining a result when three test products Nos. 1 to 3 having different web thicknesses W and land/groove ratios θ₁:θ₂ are prepared to perform a boring process while increasing a feed amount under the predetermined test condition and examine limit values of feed amounts.

FIGS. 10A to 10D are diagrams for explaining a result when the three test products Nos. 1 to 3 same as FIGS. 9A to 9D are used to perform a boring process while increasing a feed amount under the test condition that is different from FIGS. 9A to 9D and examine limit values of feed amounts.

### DESCRIPTION OF REFERENCE NUMERALS

10: drill 12: twist groove 14: main cutting edge 16: thinning 18: thinning edge 20: negative angle portion O: drill axial center D: drill diameter φ: radial rake angle L: negative angle range θ₁: land width angle θ₂: groove width angle

### BEST MODES FOR CARRYING OUT THE INVENTION

The present invention is applied to a three-blade drill in a preferred manner and is also applicable to a drill having four or more blades. A twist groove is twisted in the same direction as a drill rotation direction when viewed from the shank side to evacuate chips toward the shank side, and a twist angle is suitably set within a range of about 10° to 50°, for example. Various tool materials such as cemented carbide and high-speed tool steel can be used for a material of the drill and the drill is coated with hard coating such as TiAlN, TiCN, TiN, and diamond, as needed. A fluid supply hole (oil hole) longitudinally penetrating in the axial direction and opening in a flank at a tip can also be provided.

The drill of the present invention is particularly effective when used at a high feed rate with a feed amount per rotation exceeding 5% and, moreover, 10% of the drill diameter D and can also be used for a normal boring process with a feed amount per rotation less than 5% of the drill diameter D. The drill of the present invention is used in a preferred manner for the boring processes of various work materials such as boring processes of cast iron, general steel, etc., requiring a relatively high rigidity and boring processes of aluminum alloy, etc., causing relatively poor chip evacuation.

If a radial rake angle φ in a bottom view is φ<−20°, the cutting resistance and the thrust resistance increase and the sharpness deteriorates while chipping and a defect are likely to occur in the vicinity of an outer peripheral corner in the case of 0°≦φ and, therefore, the radial rake angle φ is set within a range of −20°≦φ<0°. If a negative angle range L exceeds 0.1 D, the cutting resistance and the thrust resistance increase and the sharpness deteriorates, the negative angle range L is set to L≦0.1 D. Although the radial rake angle φ may be set substantially constant in the negative angle range L, for example, and a main cutting edge may be formed substantially linearly in a bottom view, the main cutting edge may have a shape curved convexly toward the drill rotation direction such that the radial rake angle φ gradually increase (negative→0°) from the outer peripheral corner toward the inside (toward the tip). The negative angle range L is a linear distance from the outer peripheral corner in the direction toward a drill axial center O.

The main cutting edge forms a concave arc shape smoothly recessed toward the side opposite to the drill rotation direction in a bottom view in a portion closer to the drill axial center O than a negative angle portion, and an appropriate radius of the concave arc shape is within a range of about 0.19 D to 1.1 D, for example. The arc may not necessarily have a constant radius and may have a continuously changing curvature. Although this concave arc shape portion is formed such that a radial rake angle γ is positive in a portion on the outer peripheral side connected to the negative angle portion, gradually decreases toward the drill axial center O (positive→0°), and becomes negative in a portion on the inner peripheral side connected to a thinning edge, for example.

If a rate of a groove width angle θ₂ becomes greater than 35:65 in a land/groove ratio θ₁:θ₂, a land width angle θ₁ decreases and the tool rigidity and cutting edge strength deteriorate; in contrast, if a rate of the groove width angle θ₂ becomes smaller than 65:35, the chip evacuation performance deteriorates; and therefore, a range of 35:65 to 65:35 is desirable. Although the twist grooves are disposed at regular angular intervals around the drill axial center O, for example, the twist grooves can be disposed at irregular intervals and, even in such a case, it is desired that all the land/groove ratios θ₁:θ₂ are set within a range of 35:65 to 65:35.

If a web thickness W at the drill tip is smaller than 0.25 D, the tool rigidity and cutting edge strength deteriorate; in contrast, if the web thickness W is greater than 0.45 D, the chip evacuation performance deteriorates; and therefore, a range of 0.25 D to 0.45 D is desirable. Although the web thickness W may be constant across the full length of a drill body portion disposed with the twist grooves, a back taper can be provided such that the web thickness W decreases from the drill tip toward the shank side.

If an axial rake angle in the portion of the thinning edge closest to the drill axial center O is smaller than −5° (larger on the negative side), the cutting resistance and the thrust resistance increase; if greater than 0°, i.e., positive, the blade edge strength deteriorates; and therefore, it is desired that the axial rake angle is within a range of −5° to 0°. In a connection portion for the main cutting edge, if the axial rake angle is smaller than 0°, i.e., negative, the cutting resistance increases; if greater than +15°, the blade edge strength deteriorates; and therefore, it is desired that the axial rake angle is within a range 010° to +15°.

### Embodiments

Embodiments of the present invention will now be described in detail with reference to the drawings.

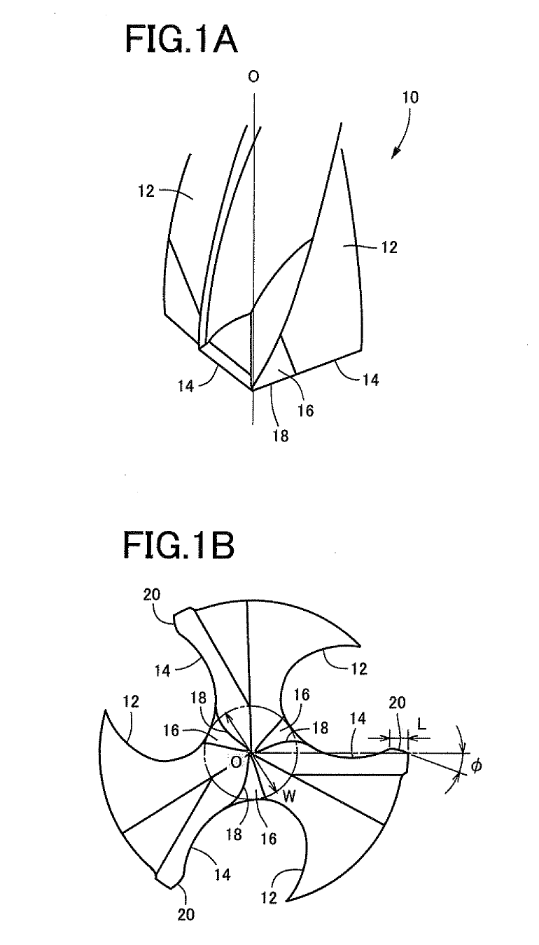

FIGS. 1A and 1B depict a drill 10 that is an embodiment of the present invention; FIG. 1A is a front view of a tip portion when viewed in the direction normal to the axial center O; and FIG. 1B is an enlarged bottom view from the tip side. The drill 10 is a three-blade drill made of cemented carbide and disposed with three main cutting edges 14 at a cone-shaped tip portion by spirally forming three twist grooves 12 around the drill axial center O at regular angular intervals. The twist grooves 12 are twisted in the same direction as a drill rotation direction (clockwise direction in this embodiment) when viewed from the shank side, i.e., from the upper side of FIG. 1A, by a predetermined twist angle within a range of about 10° to 50° (e.g., about 30°) to evacuate chips toward the shank side. A drill body portion disposed with the twist grooves 12 is coated with hard coating such as TiAlN as needed. A fluid supply hole (oil hole) can be provided that longitudinally penetrates a shank in the axial direction from a rear end, opening in a flank at a tip.

Thinning 16 is performed correspondingly to the three main cutting edges 14 in the vicinity of the drill axial center O at the drill tip and thinning edges 18 are disposed to be smoothly connected to the main cutting edges 14. An axial rake angle of the thinning edges 18 is within a range of −5° to 0° in the portion closest to the drill axial center O and smoothly and continuously increases (negative→positive) to be within a range of 0° to +15° in connection portions for the main cutting edges 14 from the side of the drill axial center O toward the connection portion.

Outer periphery portions of the main cutting edges 14 are disposed with negative angle portions 20 having a negative radial rake angle φ in a bottom view from the drill tip, i.e., in the state of FIG. 1B. The negative angle portions 20 are portions having the radial rake angle φ of −20°≦φ<0° and a negative angle range L thereof is equal to or less than 0.1 D relative to a drill diameter D as a linear distance in the direction from an outer peripheral corner toward the drill axial center O. In the negative angle range L, the main cutting edge 14 forms a shape smoothly and convexly curved and protruded in the drill rotation direction, i.e., in the counterclockwise direction around the drill axial center O in FIG. 1B, and the radial rake angle φ is smallest (largest on the negative side) at the outer peripheral corner and gradually increases toward the drill axial center O (toward the drill tip) (negative→0°). The radial rake angle φ depicted in FIG. 1B is an angle at the outermost outer peripheral corner portion and the radial rake angle q at this portion is set to a predetermined angle within a range of −20°≦φ<0°.

A portion closer to the drill axial center O than the negative angle portion 20 forms a concave arc shape smoothly recessed toward the side opposite to the drill rotation direction in the bottom view depicted in FIG. 1B, i.e., in the clockwise direction around the drill axial center O in FIG. 1B. The concave arc shape has a radius within a range of 0.19 D to 1.1 D relative to the drill diameter D and is defined as an arc shape having a constant radius of about 0.23 D, for example, and although the radial rake angle φ is positive in a portion on the outer peripheral side connected to the negative angle portion 20, the radial rake angle φ gradually decreases toward the drill axial center O to be negative and is set to a predetermined negative angle in a portion on the inner peripheral side connected to the thinning edge 18. A boundary between the convex-shaped negative angle portion 20 and the concave arc shape is smoothly connected by a small convex arc.

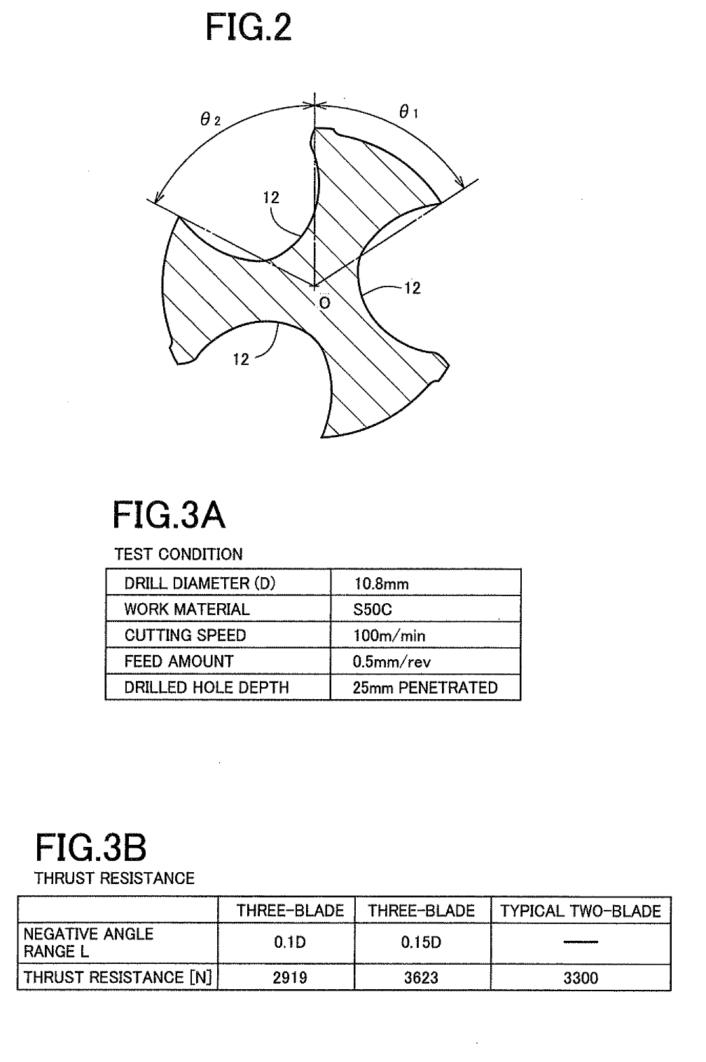

A web thickness W at the drill tip is within a range of 0.25 D to 0.45 D relative to the drill diameter D. Although the web thickness W may be constant across the full length of a drill body portion disposed with the twist grooves 12, a predetermined back taper is provided such that the web thickness W decreases from the drill tip toward the shank side in this embodiment. FIG. 2 is a cross-section normal to the drill axial center O of the drill body portion disposed with the twist grooves 12, and the land/groove ratio θ₁:θ₂, i.e., a ratio between the land width angle θ₁ around the drill axial center O and the groove width angle θ₂ of the twist grooves 12 is set within a range of 35:65 to 65:35.

In the drill 10 as described above, since the three main cutting edges 14 are disposed around the drill axial center O at regular angular intervals, the web thickness W can be increased to improve the rigidity while ensuring a predetermined chip evacuation performance as compared to two-blade drills; the centripetal property is improved to suppress the center deviation; and an enlargement amount of a processed hole diameter is reduced to enhance a processed hole accuracy. On the other hand, since the outer peripheral portions of the main cutting edges 14 are disposed with the negative angle portions 20 having a negative radial rake angle φ, the cutting edge strength is improved in the vicinity of the outer peripheral corners and, due to the synergetic effect, chipping-off and defects or the like are suppressed in the vicinity of the outer peripheral corners and a highly efficient process can be executed at a high feed rate even if a boring process is performed at a high feed rate with a feed amount per rotation exceeding 5% of the drill diameter D in the case of steel and 30% of the drill diameter D in the case of aluminum alloy, for example.

In such a case, since the radial rake angle φ of the negative angle portions 20 is within a range of −20°≦φ<0° and the range L of the negative angle portions 20 is equal to or less than 0.1 D from the outer peripheral corner, the increase in the cutting resistance and the thrust resistance or the reduction of sharpness due to a negative angle is suppressed to the requisite minimum, and the highly efficient process at a high feed rate is enabled as a whole. The portion closer to the drill axial center O than the negative angle portion 20 is formed into a concave arc shape smoothly recessed toward the side opposite to the drill rotation direction and, therefore, the chip evacuation performance is improved since chips are promoted to curl up and easily parted while a cutting load is distributed due to a cutting edge length longer than a linear cutting edge, which is advantageous for the highly efficient process at a high feed rate.

Therefore, the chip evacuation performance and the tool rigidity and cutting edge strength are improved in a balanced manner while suppressing increases in the cutting resistance and the thrust resistance to enable the highly efficient process performed at a high feed rate, and the drill can be used in a preferred manner for the boring processes of various work materials from cast iron and general steel requiring a relatively high rigidity, to aluminum alloy, etc., causing poor chip evacuation.

In this embodiment, the land/groove ratio θ₁:θ₂ is within a range of 35:65 to 65:35 and, therefore, the chip evacuation performance and the tool rigidity and cutting edge strength can be ensured in a balanced manner, which is advantageous for the highly efficient process at a high feed rate.

In this embodiment, the web thickness W at the drill tip is within a range of 0.25 D to 0.45 D relative to the drill diameter D and, therefore, the chip evacuation performance and the tool rigidity and cutting edge strength can be ensured in a balanced manner, which is advantageous for the highly efficient process at a high feed rate.

Since the axial rake angle of the thinning edges 18 is within a range of −5° to 0° in the portion closest to the drill axial center O and smoothly and continuously increases to be within a range of 0° to +15° in the connection portions for the main cutting edges 14 from the side of the drill axial center O toward the connection portion in this embodiment, a predetermined blade edge strength can be ensured while suppressing increases in the cutting resistance and the thrust resistance and, therefore, the defects are suppressed in the connection portions between the thinning edges 18 and the main cutting edges 14, which is advantageous for the highly efficient process at a high feed rate.

According to the drill 10 of this embodiment, the chip evacuation performance and the tool rigidity and cutting edge strength are improved in a balanced manner while suppressing increases in the cutting resistance and the thrust resistance and, therefore, the highly efficient boring process can be performed at a high feed rate with a feed amount per rotation exceeding 5% and, moreover, 10% of the drill diameter D, for example. Since such a high feed rate can be realized, the number of rotations per hole is reduced and the improvement of the tool life can be expected.

On the other hand, since the chip evacuation performance and the tool rigidity and cutting edge strength are ensured in a balanced manner while suppressing increases in the cutting resistance and the thrust resistance, the drill can be used in a preferred manner for the boring processes of various work materials from cast iron and general steel requiring a relatively high rigidity, to aluminum alloy, etc., causing relatively poor chip evacuation. According to the experiments by the inventor et al., when a boring process of φ8.8 mm (=drill diameter D) is performed in a work material of “S50C (carbon steel for machine structural use)” (JIS standard), a feed amount per rotation can be increased to 0.7 mm (≈0.08 D); when a boring process of φ6.8 mm (=drill diameter D) is performed in a work material of “FC250 (gray cast iron)” (JIS standard), a feed amount per rotation can be increased to 1.84 mm (≈27 D); when a boring process of φ8.0 mm (=drill diameter D) is performed in a work material of “FCD600 (nodular graphite cast iron)” (JIS standard), a feed amount per rotation can be increased to 1.28 mm (≈16 D); and when a boring process of 6.0 mm (=drill diameter D) is performed in a work material of “ADC12 (aluminum alloy die casting)” (JIS standard), a feed amount per rotation can be increased to 2.1 mm (≈35 D).

FIGS. 3A and 3B depict a result of an examination of a relationship between the negative angle range L disposed with the negative angle portion 20 and the thrust resistance, and two three-blade drills having the negative angle range L=0.1 D and 0.15 D and a typical two-blade drill having a conventional linear main cutting edge without the negative angle portion 20 are prepared as depicted in FIG. 3B to measure their respective thrust resistances by performing a boring process under the test condition depicted in FIG. 3A. Both of the three-blade drills have the web thickness W of 0.3 D and the land/groove ratio θ₁:θ₂ of 40:60 and the typical two-blade drill has the land/groove ratio θ₁:θ₂ of 50:50. The radial rake angle φ is −10° at the outer peripheral corner of the three-blade drills including the negative angle portions 20. As can be seen from the result depicted in FIG. 3B, while the thrust resistance is greater than that of the conventional typical two-blade drill in the case of the three blades with L=0.15 D, the three-blade drill with L=0.1 D generates the thrust resistance smaller than the conventional typical two-blade drill and, because a smaller thrust resistance is desirable for enabling a higher feed rate, the negative angle range L is defined to be equal to or less than 0.1 D.

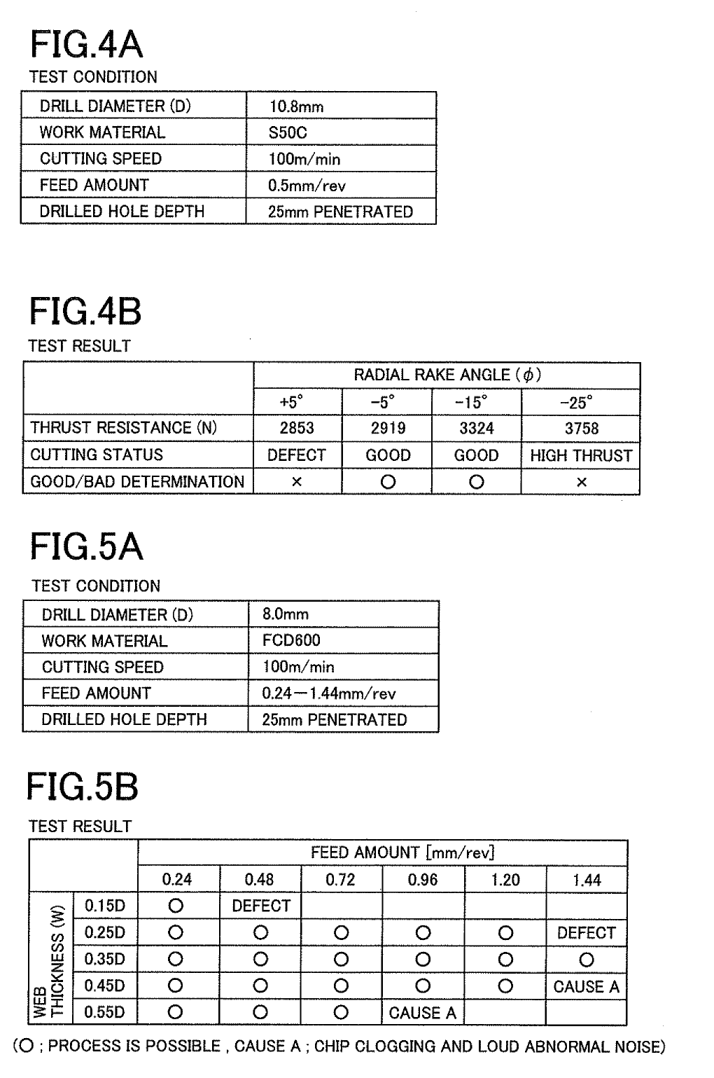

FIGS. 4A and 4B are diagrams for explaining a result when four three-blade drills having the radial rake angles φ of +5°, −5°, −15°, and −25° at the outer peripheral corners are prepared to measure the thrust resistances by performing boring processes under the test condition depicted in FIG. 4A and the cutting statuses are observed to judge whether good or bad in a comprehensive manner. All the four test products have the web thickness W=03 D and the land/groove ratio θ₁:θ₂=40:60, and the drills with the negative radial rake angles φ have the negative angle range L=0.05 D. As can be seen from the result depicted in FIG. 4B, φ=+5° is NG because the main cutting edges 14 tend to be defective although the thrust resistance is small and φ=−25° is NG because of large thrust resistance and poor sharpness. Therefore, an appropriate radial rake angle φ is within a range of −20°≦φ<0° and it is particularly desirable to be within a range of −15° to −5°.

In the case of FIGS. 5A and 5B, five three-blade drills having the web thicknesses W of 0.15 D, 0.25 D, 0.35 D, 0.45 D, and 0.55 D are prepared to perform a boring process of 10 holes for each drill under the test condition depicted in FIG. 5A, and a feed amount per rotation is increased in a stepwise manner if the process is possible “∘”. All the five test products have the land/groove ratio θ₁:θ₂=40:60, the negative angle range L=0.05 D for the negative angle portions 20, and the radial rake angle φ=−10° at the outer peripheral corners. As can be seen from the result depicted in FIG. 5B, in the case of the web thickness W=0.15 D, the process becomes impossible at a feed amount of 0.48 mm/rev due to a defect and, in the case of the web thickness W=0.55 D, the process becomes impossible at a feed amount of 0.96 mm/rev due to chip clogging and occurrence of abnormal noise. In all the cases of the web thicknesses W=0.25 D, 0.35 D, and 0.45 D, the boring processes can favorably be performed even at a feed amount of 1.20 mm/rev and, therefore, the appropriate web thickness W is within a range of 0.25 D to 0.45 D.

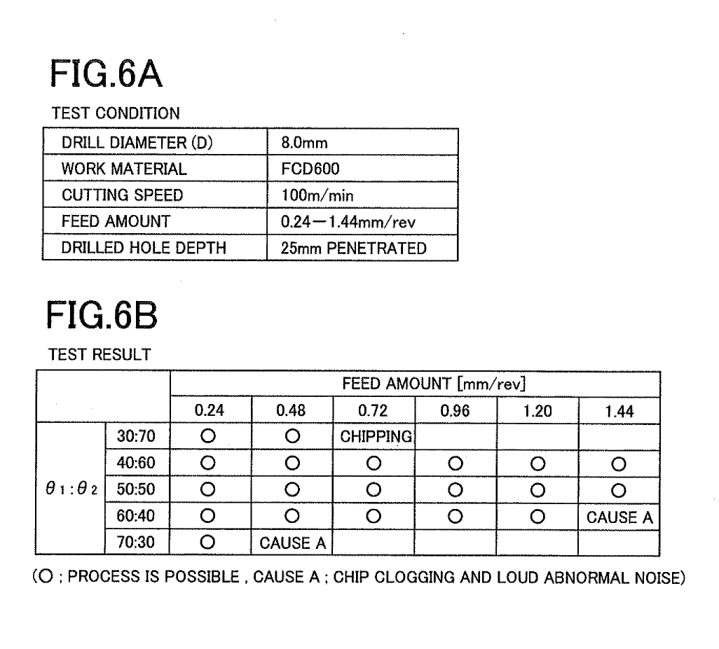

In the case of FIGS. 6A and 6B, five three-blade drills having the land/groove ratios θ₁:θ₂ of 30:70, 40:60, 50:50, 60:40, and 70:30 are prepared to perform a boring process of 10 holes for each drill under the test condition depicted in FIG. 6A and a feed amount per rotation is increased in a stepwise mariner if the process is possible “∘”. All the five test products have the web thicknesses W=0.3 D, the negative angle range L=0.05 D for the negative angle portions 20, and the radial rake angle φ=−10° at the outer peripheral corners. As can be seen from the result depicted in FIG. 6B, in the case of the land/groove ratio θ₁:θ₂=30:70, the process becomes impossible at a feed amount of 0.72 mm/rev due to chipping and, in the case of the land/groove ratio θ₁:θ₂=70:30, the process becomes impossible at a feed amount of 0.48 min/rev due to chip clogging and occurrence of abnormal noise. In all the cases of the land/groove ratios θ₁:θ₂=40:60, 50:50, and 60:40, the process can favorably be performed even at a feed amount of 1.20 mm/rev and, therefore, the appropriate land/groove ratio θ₁:θ₂ is within a range of 35:65 to 65:35.

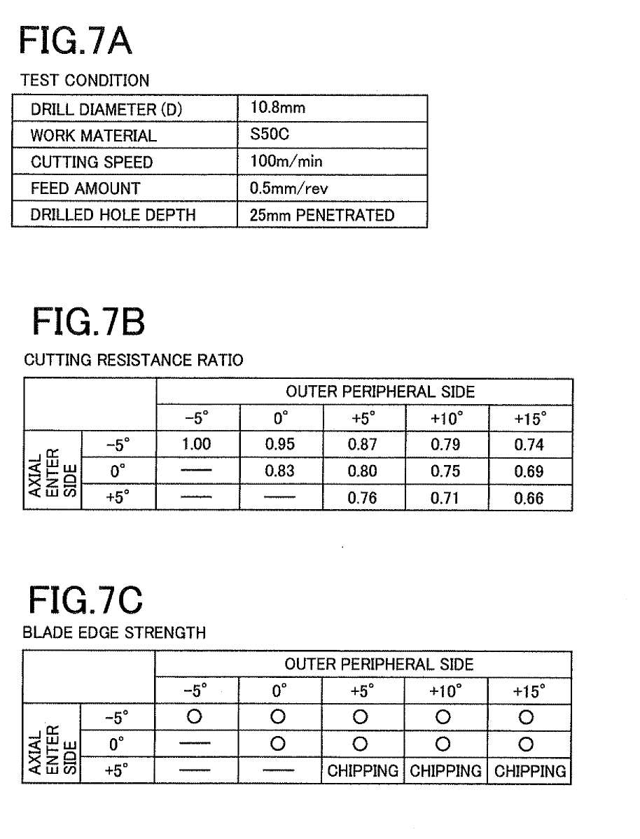

FIGS. 7A to 7C depict a result when a plurality of three-blade drills is prepared that have an axial rake angle of the thinning edges 18 smoothly and continuously changing between different axial rake angles on the axial center side, i.e., at the ends closer to the drill axial center O (vertical fields of FIGS. 7B and 7C) and axial rake angles on the outer peripheral side, i.e., in the connection portions for the main cutting edges 14 (horizontal fields of FIGS. 7B and 7C) and a boring process of 10 holes is performed for each drill under the test condition depicted in FIG. 7A to compare the cutting resistances (average values of 10 holes) and examine the blade edge strengths. Each of a plurality of test products has the land/groove ratio θ₁:θ₂=40:60, the web thickness W=0.3 D, the negative angle range L=0.05 D for the negative angle portions 20, and the radial rake angle φ=−10° at the outer peripheral corners.

The cutting resistance ratios of FIG. 7B indicate the cutting resistances of the drills for comparison by using the cutting resistance of the drill having the axial rake angle of −5′ on the axial center side and the axial rake angle of −5° on the outer peripheral side as a benchmark (1.00) and the blade edge strengths of FIG. 7C indicate a result of examination of the presence of chipping (“∘” indicates absence of chipping). Judging comprehensively from these results, the appropriate axial rake angle on the axial center side is within a range of −5° to 0° in terms of blade edge strength; the appropriate axial rake angle on the outer peripheral side is within a range of 0° to +15° in terms of cutting resistance; and it is desired that the axial rake angle is smoothly and continuously changed therebetween.

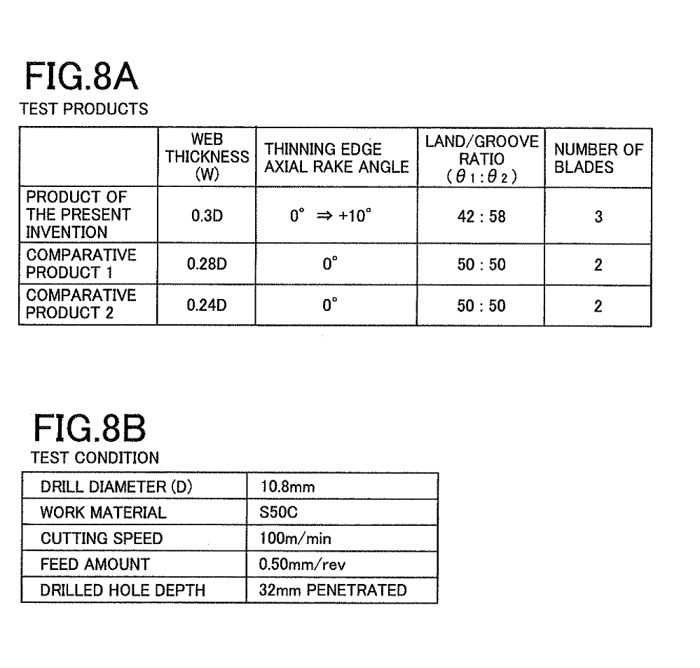

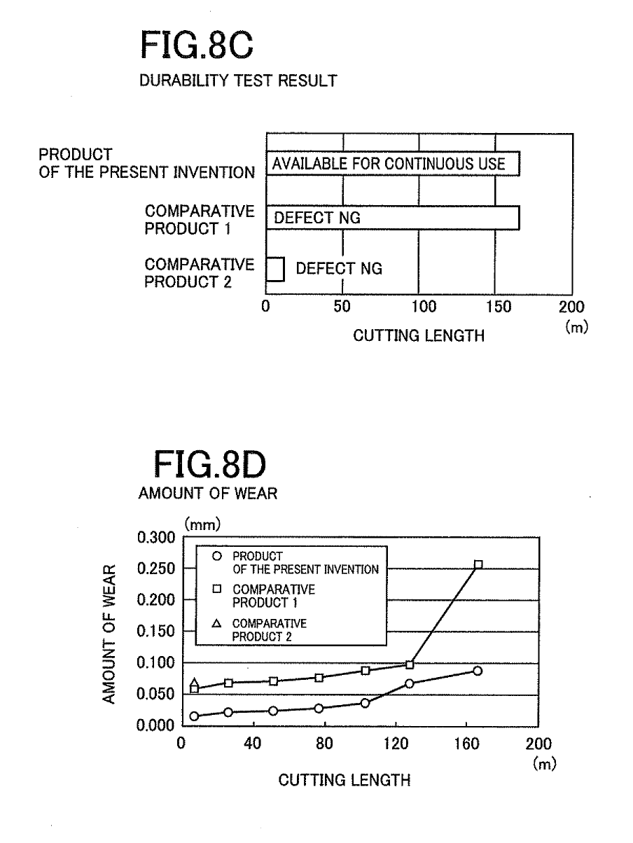

FIGS. 8A to 8D depict a result when a product of the present invention and two comparative products are prepared as depicted in FIG. 8A and a boring process is performed under the test condition depicted in FIG. 8B to examine durability and amounts of wear in the outer peripheral corner portion. “0°→+10°” in a field of “thinning edge axial rake angle” of FIG. 8A means that an axial rake angle gradually increases in a smooth and continuous manner between the axial rake angle on the axial center side, which is 0°, and the axial rake angle on the outer peripheral side, which is +10°. As can be seen from the results of the durability and the amounts of wear in FIGS. 8C and 8D, respectively, the product of the present invention has a smaller amount of wear in the outer peripheral corner portion as compared to the two-blade comparative products 1 and 2, ensuring excellent durability.

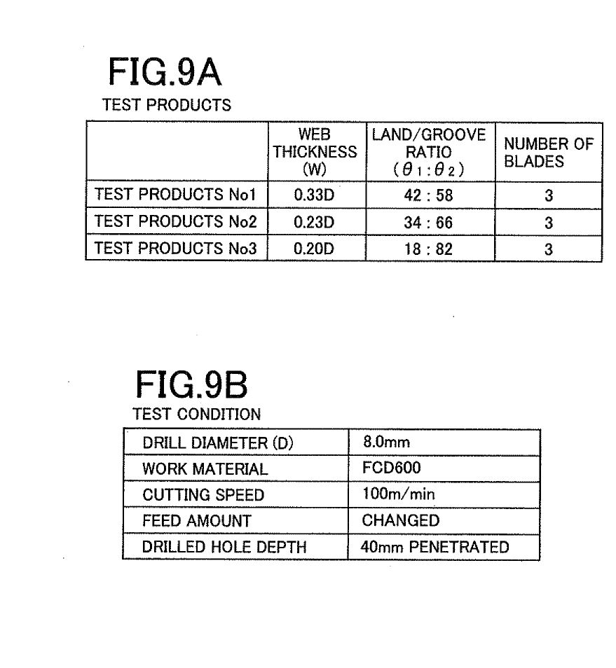

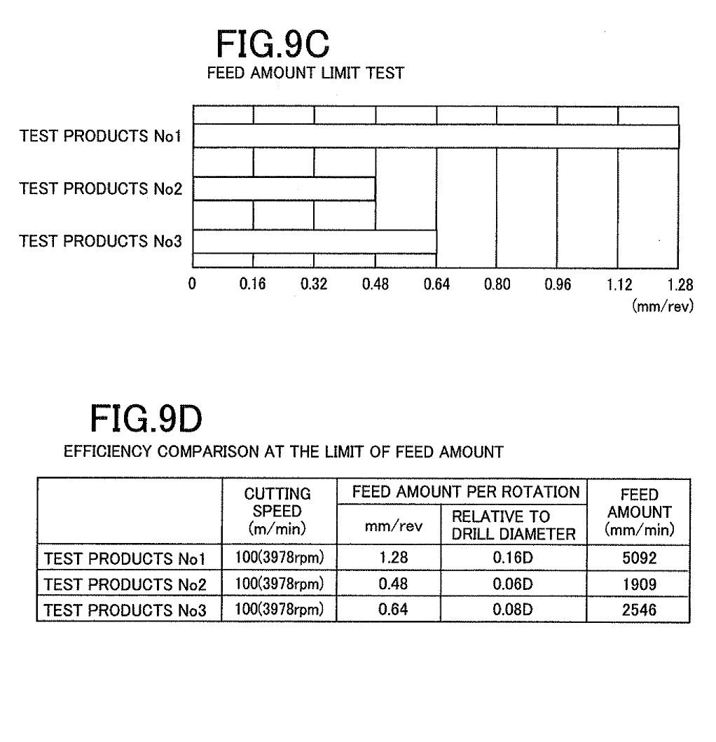

In the case of FIGS. 9A to 9D, three three-blade drills having different web thicknesses W and land/groove ratios θ₁:θ₂ as described in FIG. 9A are prepared as test products Nos. 1 to 3 to perform a boring process of 10 holes for each drill under the test condition depicted in FIG. 9B and a feed amount is increased in a stepwise manner if the process is possible. Each of the three test products Nos. 1 to 3 has the negative angle range L=0.05 D for the negative angle portions 20 and the radial rake angle φ=−40° at the outer peripheral corners and is one embodiment of the present invention, and the test product No. 1 also satisfies the requirements of claims 2 and 3. FIG. 9C depicts limit values of feed amounts while FIG. 9D depicts feed amounts per rotation converted into rates relative to the drill diameter D and feed amounts per minute, and all the products are capable of the highly efficient process at a high feed rate not less than 6% of the drill diameter D (0.06 D). Especially, the test product No. 1 has the web thickness W satisfying the requirement of claim 3 (0.25 D≦W<0.45 D) and the land/groove ratio θ₁:θ₂ satisfying the requirement of claims 2 (35:65 to 65:35) and is capable of a high feed rate of 16% of the drill diameter D.

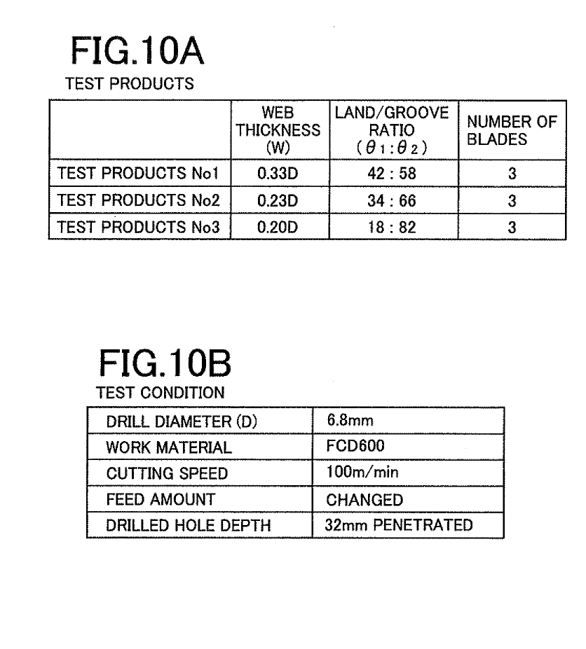

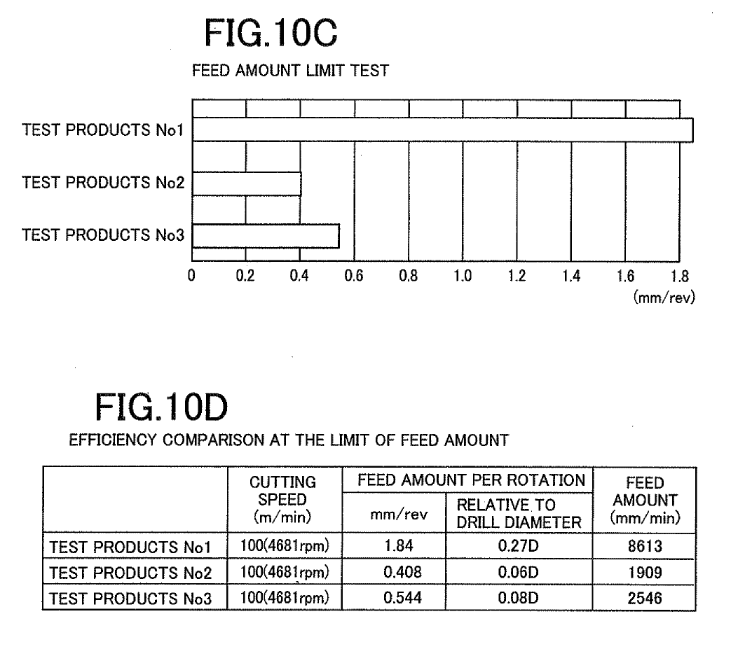

In the case of FIGS. 10A to 10D, although the three three-blade test products Nos. 1 to 3 same as FIGS. 9A to 9D are used as depicted in FIG. 10A, differences are that the drill diameter is 6.8 mm and that a through hole is drilled with a processed hole depth of 32 mm as depicted in FIG. 10B; a boring process of 10 holes is performed for each drill as is the case with FIGS. 9A to 9D; a feed amount is increased in a stepwise manner if the process is possible; and FIGS. 10C and 10D correspond to FIGS. 9C and 9D, respectively. In this case, all the test products Nos. 1 to 3 are capable of the highly efficient process at a high feed rate not less than 6% of the drill diameter D (0.06 D) and, especially, the test product No. 1 is capable of a high feed rate of 27% of the drill diameter D.

Describing a processed hole accuracy in detail, when a boring process of “S50C (carbon steels for machine structural use)” (JIS standard) was performed by using a three-blade product of the present invention and a two-blade conventional drill, a processed hole diameter is enlarged by about 15 μM on an average in the case of the two-blade conventional drill while the three-blade product of the present invention causes an enlargement amount of about 6 μm, which is not greater than ½.

Although the embodiments of the present invention have been described in detail with reference to the drawings, these embodiments are merely exemplary embodiments and the present invention may be implemented in variously modified or altered forms based on the knowledge of those skilled in the art.

### INDUSTRIAL APPLICABILITY

The drill of the present invention having the three or more main cutting edges, and the main cutting edges disposed with a negative angle portion having a negative radial angle in an outer peripheral portion, and a radial rake angle φ in the negative angle portion is set within a range of −20°≦φ<0°, a negative angle range L is set in a range not greater than 0.1 D relative to a drill diameter D from an outer peripheral corner. The main cutting edge forming a concave arc shape smoothly recessed toward a side opposite to a drill rotation direction in a portion closer to the drill axial center O than the negative angle portion. Therefore, the chip evacuation performance and the tool rigidity and cutting edge strength are improved in a balanced manner while suppressing increases in the cutting resistance and the thrust resistance to enable the highly efficient process performed at a high feed rate, and the drill can be used in a preferred manner for the boring processes of various work materials from cast iron and general steel requiring a relatively high rigidity, to aluminum alloy, etc., causing poor chip evacuation.

1. A drill having a plurality of twist grooves disposed around a drill axial center O and main cutting edges formed along their respective twist grooves in opening portions of the twist grooves at a drill tip, the drill being subjected to thinning in the vicinity of the drill axial center O at the drill tip to dispose thinning edges smoothly connected to the main cutting edges,
the drill being disposed with the three or more twist grooves and the three or more main cutting edges,
the main cutting edges having a negative angle portion in an outer peripheral portion having a radial rake angle φ within a range of −20°≦φ<0° in a bottom view from the drill tip side and a shape curved convexly toward the drill rotation direction, the negative angle portion being formed in a range L not greater than 0.1 D relative to a drill diameter D from an outer peripheral corner,
the main cutting edge forming a concave arc shape smoothly recessed such that it projects toward a side opposite to a drill rotation direction beyond a straight line that passes through the outer peripheral corner and the drill axial center O in the bottom view in a portion closer to the drill axial center O than the negative angle portion, and
a ratio between a land width angle θ₁ around the drill axial center O and a groove width angle θ₂ of the twist grooves being within a range of 35:65 to 65:35.

2. (canceled)

3. The drill of claim 1, wherein a web thickness W at the drill tip is within a range of 0.25 D to 0.45 D relative to the drill diameter D.

4-6. (canceled)

7. The drill of claim 1, wherein an axial rake angle of the thinning edges is within a range of −5° to 0° in a portion closest to the drill axial center O and smoothly and continuously increases to be within a range of 0° to +15° in a connection portion for the main cutting edge from the side of the drill axial center O toward the connection portion.

8. The drill of claim 3, wherein an axial rake angle of the thinning edges is within a range of −5° to 0° in a portion closest to the drill axial center O and smoothly and continuously increases to be within a range of 0° to +15° in a connection portion for the main cutting edge from the side of the drill axial center O toward the connection portion.

9. A drill having a plurality of twist grooves disposed around a drill axial center O and main cutting edges formed along their respective twist grooves in opening portions of the twist grooves at a drill tip, the drill being subjected to thinning in the vicinity of the drill axial center O at the drill tip to dispose thinning edges smoothly connected to the main cutting edges,
the drill being disposed with the three or more twist grooves and the three or more main cutting edges,
the main cutting edges having a negative angle portion in an outer peripheral portion having a radial rake angle φ within a range of −20°≦φ<0° in a bottom view from the drill tip side and a shape curved convexly toward the drill rotation direction, the negative angle portion being formed in a range L not greater than 0.1 D relative to a drill diameter D from an outer peripheral corner,
the main cutting edge forming a concave arc shape smoothly recessed such that it projects toward a side opposite to a drill rotation direction beyond a straight line that passes through the outer peripheral corner and the drill axial center O in the bottom view in a portion closer to the drill axial center O than the negative angle portion,
the drill having a ratio between a land width angle θ₁ around the drill axial center O and a groove width angle θ₂ of the twist grooves within a range of 35:65 to 65:35, the drill having a web thickness W at the drill tip within a range of 0.25 D to 0.45 D relative to the drill diameter D,
the drill having an axial rake angle of the thinning edges within a range of −5° to 0° in a portion closest to the drill axial center O, the axial rake angle smoothly and continuously increasing to be within a range of 0° to +15° in a connection portion for the main cutting edge from the side of the drill axial center O toward the connection portion.

10. The drill of claim 1, wherein the drill is capable of a high feed rate process for steel with a feed amount per rotation exceeding 5% of the drill diameter D and is capable of a high feed rate process for aluminum alloy with a feed amount per rotation exceeding 30% of the drill diameter D.

11. The drill of claim 3, wherein the drill is capable of a high feed rate process for steel with a feed amount per rotation exceeding 5% of the drill diameter D and is capable of a high feed rate process for aluminum alloy with a feed amount per rotation exceeding 30% of the drill diameter D.

12. The drill of claim 7, wherein the drill is capable of a high feed rate process for steel with a feed amount per rotation exceeding 5% of the drill diameter D and is capable of a high feed rate process for aluminum alloy with a feed amount per rotation exceeding 30% of the drill diameter D.

13. The drill of claim 8, wherein the drill is capable of a high feed rate process for steel with a feed amount per rotation exceeding 5% of the drill diameter D and is capable of a high feed rate process for aluminum alloy with a feed amount per rotation exceeding 30% of the drill diameter D.

14. The drill of claim 9, wherein the drill is capable of a high feed rate process for steel with a feed amount per rotation exceeding 5% of the drill diameter D and is capable of a high feed rate process for aluminum alloy with a feed amount per rotation exceeding 30% of the drill diameter D.
